(19) United States
(12) Patent Application Publication
(10) Pub. No.: US 2006/0199617 A1
(43) Pub. Date: Sep. 7, 2006

(54) Apparatus and method for illuminating a key pad of a mobile communication terminal

(75) Inventors: Nam-Ho Kim, Seoul (KR); Guk-Chan Lim, Gyeonggi-Do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/369,479

(22) Filed: Mar. 6, 2006

(30) Foreign Application Priority Data
Mar. 7, 2005 (KR) 10-2005-0018824

(51) Int. Cl. H04B 1/38; H04M 1/00

(52) U.S. Cl. 455/566

(57) ABSTRACT

An apparatus and method is provided for allowing an improved power key function of a mobile communication terminal that enhances user convenience by providing an independent backlight function for the power key when a mobile communication terminal is opened while in a power OFF state. By providing an independent backlight function for a power key of the mobile communication terminal, the present invention facilitates illuminating the power key when the mobile communication terminal is opened and in a power OFF state.

### CROSS-REFERENCE TO RELATED APPLICATIONS

Pursuant to 35 U.S.C. § 119(a), this application claims the benefit of earlier filing date and right of priority to Korean Application No. 10-2005-0018824, filed on Mar. 7, 2005, the contents of which is hereby incorporated by reference herein in its entirety

### BACKGROUND OF THE INVENTION

1. Field of the Invention

The present invention relates to a mobile communication terminal, and more particularly, to an apparatus and method for illuminating a power key of a mobile communication terminal in order to enhance user convenience.

2. Description of the Related Art

A mobile communication terminal is a device that allows a user to communicate with other persons over a wireless (radio) interface through communication control operations performed by, for example, a mobile switching center (MSC) while traveling in a service area managed by, for example, a base station (BS). Current mobile communication terminals can support multimedia communications functions including sending and receiving images or video, as well as voice communications functions including sending and receiving phone calls.

In addition to these basic communication functions, mobile communication terminals have various supplementary functions, such as camera functions, music player functions (e.g., playback of MP3 (MPEG-Audio-Layer-3) music files), Internet access functions and text messaging (SMS) functions. Recently, the external shape and the user interface of mobile communication terminals have been considered important factors in designing mobile communication terminals in addition to providing supplementary functions.

Operating or driving the backlight for a keypad is another function provided in a mobile communication terminal. An apparatus used in performing the operational functions for the keypad of a mobile communication terminal will be described with reference to FIG. 1. FIG. 1 is a block diagram illustrating an apparatus 10 for illuminating a keypad of the mobile communication terminal in accordance with the related art.

As illustrated in FIG. 1, the apparatus 1 includes a Hall-effect switch 10 that is turned on or off according to an open or closed state of the mobile communication terminal, a detector unit 20 that detects an open or closed state of the mobile communication terminal and a driving unit 30 for driving a backlight 40 of a keypad at the mobile communication terminal. The detection unit 20 includes a first detection unit 22 for detecting a power ON/OFF state of the mobile communication terminal, a second detection unit 24 for detecting the open or closed state of the mobile communication terminal according to the ON/OFF state of the Hall-effect switch 10 and a comparing unit 26 for outputting a control signal based on the detected open or closed state and the power ON/OFF state, the control signals used by the driving unit 30 for driving the backlight 40.

A method for illuminating the keypad of the mobile communication terminal in accordance with the related art will be described with reference to FIG. 2. FIG. 2 is a flow chart illustrating a method for illuminating the keypad of a mobile communication terminal in accordance with the related art.

As illustrated in FIG. 2, the related art method includes detecting whether the mobile communication terminal is in an open state (S110), detecting whether the mobile communication terminal is also in ON state (S120), outputting a control signal when the mobile communication terminal is in both the open state and ON state (S130) and driving a backlight of the keypad according to the output control signal (S140).

Initially, the second detection unit 24 detects whether the mobile communication terminal is in an open state (S110) and outputs a corresponding detection result to the comparing unit 26. When the mobile communication terminal is opened, the Hall-effect switch 10 is turned on and the second detection unit 24 detects that the mobile communication terminal is in the open state (S110).

When the mobile communication terminal is in the open state, the first detection unit 22 detects whether the mobile communication terminal is also in a power ON state (S120) and outputs a corresponding detection result to the comparing unit 26. When the mobile communication terminal is in both the open state and power ON state, the comparing unit 26 outputs a control signal (S130). Specifically, when the mobile communication terminal is in both the open state and the power ON state, the comparing unit 26 determines that the user wants to use the mobile communication terminal and outputs the control signal for driving the backlight 40 of the keypad.

Accordingly, the driving unit 30 drives the backlight 40 of the keypad (S140). Specifically, when the mobile communication terminal is in the power ON state while in the open state and a certain key of the keypad is pressed, the driving unit 30 drives the backlight 40 of the keypad (S140), thereby allowing the user to easily view and operate the illuminated keypad.

However, the related art apparatus and method for operating a keypad of a mobile communication terminal are problematic in that the backlight for the entire keypad is driven only when the mobile communication terminal is open and also is in the power ON state. Therefore, at nighttime or in a dark environment where there is little or no ambient light, the user cannot easily locate the power key on the keypad if his mobile communication terminal is in the off state.

Therefore, there is a need for a system for effectively illuminating a power key of a mobile communication terminal when the terminal is open but not in the power ON state. The present invention addresses these and other needs.

### SUMMARY OF THE INVENTION

The present invention is directed to improvements in illuminating the keypad of a mobile communication terminal. The present invention provides an apparatus and method for allowing an improved power key function of a mobile communication terminal that enhances user convenience by providing an independent backlight function for the power key when a mobile communication terminal is opened while in a power OFF state.

Certain features that may be part of the mobile communication terminal of the present invention will not be described in detail, such that the characteristics of the present invention are not obscured. However, such additional features may also be part of the present invention, as would be understood by those skilled in the art.

In one aspect of the present invention, an apparatus for providing illumination of a mobile communication terminal keypad is provided. The apparatus includes a detection unit adapted to detect either an open state or a closed state of the mobile communications terminal and either a powered state or an unpowered state of the mobile communication terminal and to output a control signal based on the detected states and a driving unit adapted to illuminate a backlight of at least one keypad key according to the control signal, the keypad key illuminated independent from other keypad keys such that the keypad key is illuminated when the mobile communications terminal is in both the open state and the unpowered state.

It is contemplated that the detection unit includes a first detector adapted to detect the powered state or unpowered state, a second detector adapted to detect the open state or closed state and a comparing unit adapted to output a first control signal and a second control signal according to the states detected by the first detector and the second detector such that the first control signal is used by the driving unit to illuminate a backlight of the entire keypad and the second control signal is used by the driving unit to independently illuminate the backlight of the keypad key. Preferably, the driving unit includes a first driver adapted to drive the backlight of the entire keypad according to the first control signal and a second driver adapted to drive the backlight of the keypad key according to the second control signal.

It is contemplated that the apparatus further includes a switching unit adapted to generate a voltage and/or current according to the detected open state or closed state and the detection unit further includes a conversion unit adapted to convert the voltage and/or current such that the comparing unit outputs the second control signal when the second detector detects the open state. Preferably, the switching unit includes a Hall-effect switch.

It is contemplated that the comparing unit is further adapted to output the first control signal when the first detector detects the powered state and to output the second control signal when either the first detector detects the powered state or the second detector detects the open state. It is further contemplated that the keypad key is a power key of the mobile communications terminal. Preferably, the user specifies the keypad key.

In another aspect of the present invention, a method for illuminating a mobile communication terminal keypad is provided. The method includes detecting a first state of the mobile communications terminal, the first state either a powered state or an unpowered state, detecting a second state of the mobile communication terminal, the second state either an open state or a closed state, generating a control signal based on the detected first and second states and illuminating a backlight of at least one keypad key according to the control signal, the keypad key illuminated independent from other keypad keys such that the keypad key is illuminated when the detected first state is the unpowered state and the detected second state is the open state.

It is contemplated that generating a control signal includes generating a first control signal and a second control signal according to the detected first and second states and illuminating a backlight of the entire keypad according to the first control signal and independently illuminating the backlight of the keypad key according to the second control signal. Preferably, illuminating the backlight of the keypad key includes generating a voltage and/or current according to the detected second state and converting the voltage and/or current such that the second control signal is generated when the detected second state is the open state.

It is contemplated that generating a first control signal and a second control signal includes generating the first control signal when the detected first state is the powered state and generating the second control signal when either the detected first state is the powered state or the detected second state is the open state. It is further contemplated that illuminating a backlight of the keypad key includes determining a key selected by a user. Preferably, illuminating a backlight of the keypad key includes illuminating a power key of the mobile communications terminal.

In another aspect of the present invention, a mobile terminal is provided. The mobile terminal includes a body having a first portion and a second portion, the first and second portions adapted to move relative to each other such the mobile terminal has an open state and a closed state, a keypad including a plurality of keys, a first backlight adapted to illuminate the entire keypad, a second backlight adapted to illuminate at least one of the keypad keys, a detection unit adapted to detect whether the mobile communications terminal is in the open state or the closed state and to detect whether the mobile communication terminal is in a powered state or an unpowered state and to output a control signal based on the detected states and a driving unit adapted to illuminate the second backlight according to the control signal, the second backlight illuminated independent of the first backlight such that the keypad key is illuminated when the mobile communications terminal is in both the open state and the unpowered state.

It is contemplated that the detection unit includes a first detector adapted to detect whether the mobile communication terminal is in the powered state or the unpowered state, a second detector adapted to detect whether the mobile communications terminal is in the open state or the closed state, a comparing unit adapted to generate a first control signal and a second control signal according to the states detected by the first detector and the second detector, a first driver adapted to drive the first backlight according to the first control signal and a second driver adapted to drive the second backlight according to the second control signal.

It is contemplated that the mobile terminal further includes a switching unit adapted to generate a voltage and/or current according to whether the mobile communications terminal is in the open state or the closed state and the detection unit further includes a conversion unit adapted to convert the voltage and/or current such that the comparing unit generates the second control signal when the second detector detects the open state. Preferably, the switching unit includes a Hall-effect switch

It is contemplated that the comparing unit is further adapted to generate the first control signal when the first detector detects the powered state and to generate the second control signal when either the first detector detects the powered state or the second detector detects the open state. It is further contemplated that the keypad key is a power key of the mobile communications terminal. Preferably, a user selects the keypad key.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a schematic view illustrating a conventional apparatus for illuminating a keypad of a mobile communication terminal.

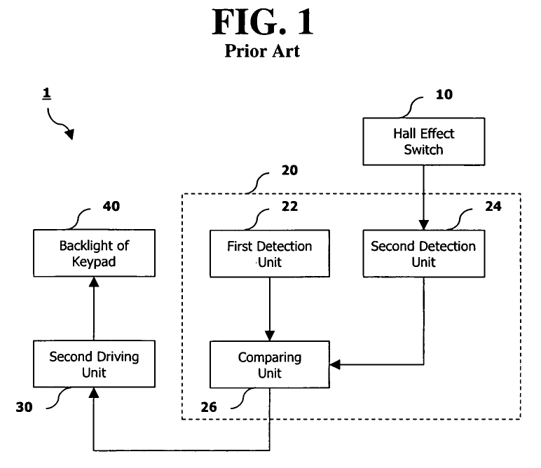

FIG. 2 is a flow chart illustrating a conventional method for illuminating the keypad of the mobile communication terminal.

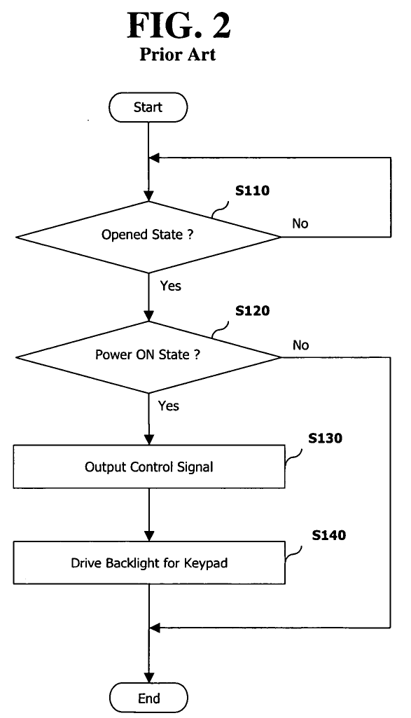

FIG. 3 is a schematic view illustrating an apparatus for illuminating a power key of a mobile communication terminal in accordance with the present invention.

FIG. 4 is a flow chart illustrating a method for illuminating the power key of a mobile communication terminal in accordance with the present invention.

FIG. 5 is a view illustrating an operation principle of the first and second driving units illustrated in FIG. 3.

### DETAILED DESCRIPTION OF THE PREFERRED EMBODIMENTS

The present invention relates to an apparatus and method for illuminating a power key of a mobile communication terminal by providing an independent backlight function for a power key when the mobile communication terminal is opened and in a power OFF state. Although the present invention is illustrated with respect to a mobile communication device, it is contemplated that the present invention may be utilized anytime it is desired to determine one's location in relation to a designated geographical location.

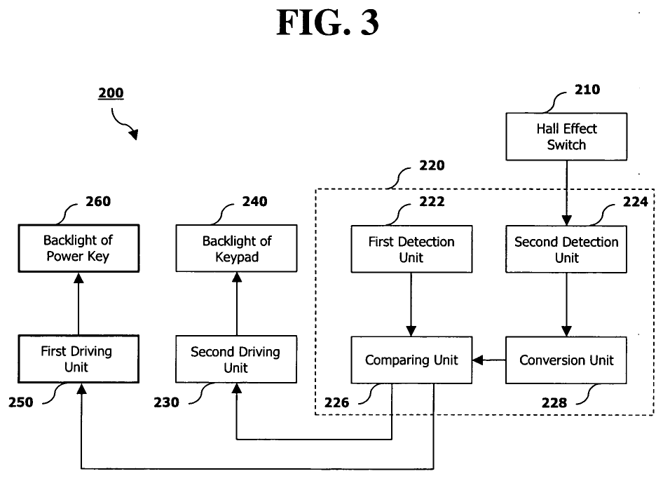

FIG. 3 is a schematic view illustrating an apparatus 200 for illuminating a power key of a mobile communication terminal in accordance with the present invention. As illustrated in FIG. 3, the apparatus 200 includes a switch 210, such as a Hall-effect switch, that turns on or off according to an open or closed state of a mobile communication terminal, a detection unit 220 that detects an open or closed state of the mobile communication terminal, a first driving unit 230 for driving a backlight 240 of a keypad at the mobile communications terminal and a second driving unit 250 for driving a backlight 260 of a power key of the mobile communications terminal. The detection unit 220 includes a first detection unit 222 for detecting a power ON or OFF state of the mobile communication terminal, a second detection unit 224 for detecting an open or closed state of the mobile communication terminal according to an ON or OFF state of the switch 2 1 0 and a comparing unit 226 for outputting a first or second control signal based on the detected open or closed state and the detected power ON or OFF state of the mobile communication terminal, the first control signal used by the first driving unit 230 to drive the backlight 240 of the keypad and the second control signal used by the second driving unit 250 to drive the backlight 260 of the power key.

When the mobile communication terminal is in the open state, a conversion unit 228 causes the comparing unit 226 to output the second control signal since a user wants to use the mobile communication terminal even though the mobile communication terminal is in the power OFF state.

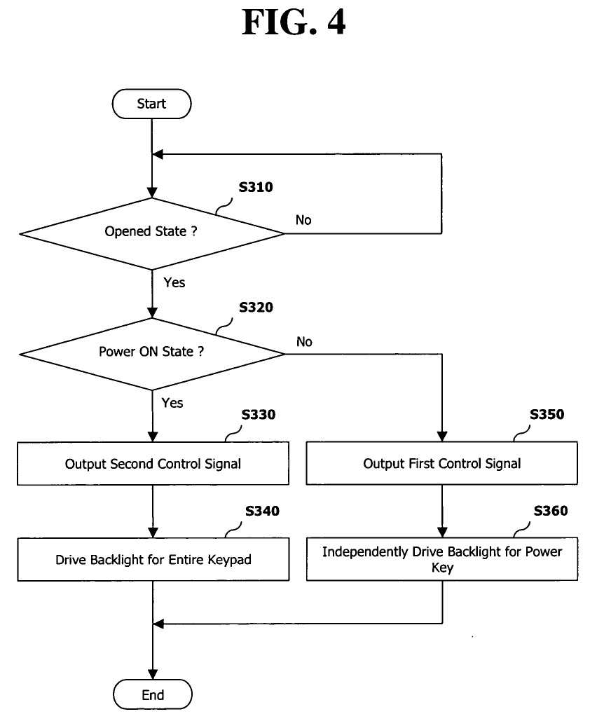

A method for illuminating the keypad of a mobile communication terminal in accordance with the present invention will be described with reference to FIG. 4. FIG. 4 is a flow chart illustrating a method for illuminating the power key of a mobile communication terminal in accordance with the present invention.

As illustrated in FIG. 4, the method includes detecting whether a mobile communication terminal is in an open state (S310) detecting whether the mobile communication terminal is also in a power ON state while in an open state (S320), outputting a first control signal when the mobile communication terminal is also in the power ON state (S330) and driving a backlight for the entire keypad (S340). When the mobile communication terminal is not also in the power ON state, the second control signal is output (S350) to independently drive the backlight 260 for the keypad (S360).

The second detection unit 224 detects whether the mobile communication terminal is in the open state (S310) and outputs a detection result to the comparing unit 226. When the mobile communication terminal is opened, the Hall-effect switch 210 is turned on and the second detection unit 224 detects that the mobile communication terminal is in the open state (S310). When the mobile communication terminal is in the open state, the first detection unit 222 detects whether the mobile communication terminal is also in a power ON state (S320) and outputs a corresponding detection result to the comparing unit 226.

When the mobile communication terminal is also in the power ON state, the comparing unit 226 outputs the first control signal (S330). Thereafter, the first driving unit 230 drives the backlight 240 for the entire keypad (S340). Specifically, when the mobile communication terminal is in both the open state and the power ON state, the comparing unit 226 outputs the first control signal (S330) for driving the backlight 240 of the entire keypad (S340). When the mobile communication terminal is in both the power ON state and the open state and a certain key of the keypad is pressed, the first driving unit 230 drives the backlight 240 of the entire keypad to allow the user to more easily view and operate the keypad.

When the mobile communication terminal is not in both the open state and the power ON state, the comparing unit 220 outputs the second control signal (S350). Thereafter, the second driving unit 250 independently drives the backlight 260 for the power key (S360). Specifically, when the mobile communication terminal is not in both the open state and power ON state, the comparing unit 226 determines that the user wants to use the mobile communication terminal and outputs the second control signal (S350) for driving the backlight 260 of the power key (S360).

Thus, the second driving unit 250 independently drives the backlight 260 of the power key according to the first control signal (S360). Specifically, the second driving unit 250 not only drives the backlight 260 of the power key when the mobile communication terminal is in both the open state and the power ON state, but also drives the backlight of the power key when the mobile communication terminal is in the open state and the power OFF state, thereby enabling the user to easily operate the keypad.

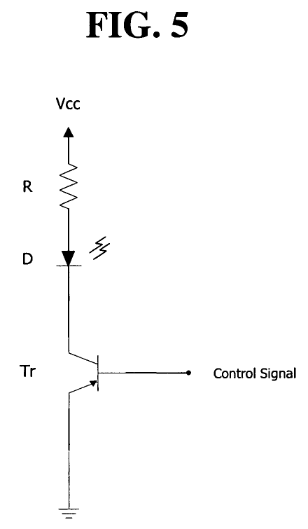

The first and second driving units 230 and 250 can separately drive the backlight 260 of the power key and the backlight 240 of the entire keypad according to the first and second control signals. The operation principle of the first 230 and second 250 driving units will be described with reference to FIG. 5. FIG. 5 illustrates an operation principle of first 230 and second 250 driving units illustrated in FIG. 3.

As illustrated in FIG. 5, the first 230 and second 250 driving units of the mobile communication terminal can drive a transistor (Tr), or other appropriate element, according to the first and second control signals. The first and second control signals are, for example, pre-set voltages to drive the backlights 240, 260 by providing a current through the transistor (Tr). The backlights 240, 260 are, for example LEDs or other type of illumination devices.

As so far described, the apparatus and method for illuminating the power key of the mobile communication terminal in accordance with the present invention is advantageous in that, by providing independent illumination of a backlight of the power key when the mobile communication terminal is opened while in a power OFF state, the user can easily recognize the power key in the dark. Therefore, user convenience is enhanced.

In the above description, the mobile terminal may be a folder type mobile phone having a folder portion that can be flipped open or closed. However, the features of the present invention can also be implemented in other types of mobile terminals, such as a slider type mobile phone, having first and second body portions that slide up and down relative to each other. Other mobile terminal configurations, such as swing-open type, bar or stick type, may also benefit from the features of the present invention.

Independent illumination of the power key is provided with a minimal amount of power from the battery, or other type of energy source, which is part of the mobile terminal. Specifically, even if the mobile terminal itself is turned off, a small amount of power can be obtained from the battery to provide illumination for the power key when the mobile terminal is opened for operation.

As an alternative or supplemental feature, a solar cell that can store light energy when a user uses his mobile phone outdoors, or in other environments where light is abundant, can be used to illuminate the power key even when the mobile terminal is turned off. Furthermore, illumination of the power key of the keypad may be achieved in many other ways, such as the power key, or at least a portion thereof, being made of a fluorescent material that glows in the dark. A power key that includes fluorescent material can further improve illumination as less power from the battery or other energy source would be required.

Additionally, other keys in addition to, or instead of, the power key may have their own separate (independent) illumination means that can provide illumination even if the mobile terminal is turned off. The user may choose or pre-set a particular key that he wishes to have illuminated when the mobile terminal is open and the mobile terminal is turned off.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A value holding apparatus operable to process a payment requested from a request apparatus, said value holding apparatus comprising:
a receiving unit operable to receive request information indicating a request for payment from the request apparatus;
a judging unit operable to judge whether the request information received by said receiving unit is invalid; and
a rejecting unit operable to reject the request information when the request information is judged to be invalid by said judging unit.

2. A value holding apparatus according to claim 1, wherein:
the payment is processed by using a value equivalent to money; and
said receiving unit is operable to receive, as the request information, information that indicates removal of the value.

3. A value holding apparatus according to claim 2, wherein said judging unit is operable to store a piece of request information last received by said receiving unit, and to judge whether the request information is invalid by using the stored piece of request information and a currently received piece of request information.

4. A value holding apparatus according to claim 3, wherein said judging unit is operable to judge that the request information is invalid when the stored piece of request information matches the currently received piece of request information.

5. A value holding apparatus according to claim 3, wherein:
each request information contains an apparatus ID identifying a request apparatus; and
said judging unit is operable to judge that the request information is invalid when an apparatus ID contained in the stored piece of request information matches an apparatus ID contained in the currently received piece of request information.

6. A value holding apparatus according to claim 3, wherein:
each request information contains a location ID identifying a location of a request apparatus, and
said judging unit is operable to judge that the request information is invalid when a location ID contained in the stored piece of request information matches a location ID contained in the currently received piece of request information.

7. A value holding apparatus according to claim 3, wherein:
each request information contains a request ID identifying the request information; and
said judging unit is operable to judge that the request information is invalid when a request ID contained in the stored piece of request information matches a request ID contained in the currently received piece of request information.

8. A value holding apparatus according to claim 3, wherein said judging unit is operable to judge that the request information is invalid when a difference between the stored piece of request information and the currently received piece of request information is within a predetermined range.

9. A value holding apparatus according to claim 3, wherein:
each request information contains time information indicating a time relating to the request; and
said judging unit is operable to judge that the request information is invalid when a difference between a time indicated by the time information in the stored piece of request information and a time indicated by the time information in the currently received piece of request information is within a predetermined range.

10. A value holding apparatus according to claim 3, wherein said value holding apparatus is structured by a handheld device and a memory card, and wherein:
said handheld device includes said receiving unit; and
said memory card includes said judging unit and said rejecting unit.

11. A value holding apparatus according to claim 3, wherein said value holding apparatus is a memory card.

12. A value holding apparatus according to claim 3, wherein said value holding apparatus is a handheld device.

13. A value holding apparatus according to claim 1, wherein:
the payment is processed by using a point; and
said receiving unit is operable to receive, as the request information, information that indicates removal of the point.

14. A value holding apparatus according to claim 1, wherein:
the payment is for use of a transport facility;
said value holding apparatus further comprises:
a zone recording unit operable to record information indicating a first zone in which a fare adjustment is unnecessary;
a location information receiving unit operable to receive, from the request apparatus, first location information that indicates a location where a use of the transport facility ends; and
said judging unit comprises:
a location information recording unit operable to record second location information that indicates a location where the use of the transport facility starts;
an obtaining unit operable to obtain a second zone in which the transport facility is used, by using the first location information and the second location information; and
a zone judging unit operable to judge whether the second zone is included in the first zone, and to judge that the request information is invalid when the second zone is judged to be included in the first zone.

15. A value holding method performed by a value holding apparatus that processes a payment requested from a request apparatus, said value holding method comprising:
receiving request information indicating a request for payment from the request apparatus;
judging whether the received request information is invalid; and
rejecting the received request information when the request information is judged to be invalid in said judging.

16. A computer program recorded on a computer-readable medium for causing a computer to execute procedures which are performed by a value holding apparatus that processes a payment requested from a request apparatus, said procedures comprising:
receiving request information indicating a request for payment from the request apparatus;
judging whether the received request information is invalid; and
rejecting the received request information when the request information is judged to be invalid in said judging.

17. A transaction system structured by a request apparatus and a value holding apparatus, wherein:
said request apparatus is operable to transmit request information indicating a request for payment to said value holding apparatus; and
said value holding apparatus comprises:
a receiving unit operable to receive request information indicating a request for payment from said request apparatus;
a judging unit operable to judge whether the request information received by said receiving unit is invalid; and
a rejecting unit operable to reject the request information when the request information is judged to be invalid by said judging unit.

18. A transaction system according to claim 17, wherein said value holding apparatus is a memory card.

19. A transaction system according to claim 17, wherein said value holding apparatus is a handheld device.

20. A transaction system according to claim 17, wherein said value holding apparatus is structured by a handheld device and a memory card, and
wherein said handheld device includes said receiving unit, and said memory card includes said judging unit and said rejecting unit.
